(19) United States
(12) Patent Application Publication
(10) Pub. No.: US 2025/0310469 A1
(43) Pub. Date: Oct. 2, 2025

(54) SYSTEMS AND METHODS FOR MANAGEMENT OF DISPLAY ELECTRONICS DURING AUDIO/VIDEO CONFERENCING

(71) Applicant: Intel Corporation, Santa Clara, CA (US)

(72) Inventors: Mukesh Arora, Bangalore (IN); Tamoghna Ghosh, Bangalore (IN); Susanta Bhattacharjee, Bangalore (IN); Vishal Ravindra Sinha, Portland, OR (US)

(73) Assignee: Intel Corporation, Santa Clara, CA (US)

(21) Appl. No.: 18/619,578

(22) Filed: Mar. 28, 2024

(51) Int. Cl. H04N 5/272; G06T 7/11; G06T 7/194; G06V 20/40

(52) U.S. Cl. CPC H04N 5/272; G06T 7/11; G06T 7/194; G06V 20/41; G06T 2207/10016; G06T 2207/30196

(57) ABSTRACT

Systems and methods for management of display electronics during audio/video conferencing. The systems first delineate a person or user from the background in a video frame, with a bounding box. The systems apply a dimming factor to pixels associated with the background in a video frame. The dimming factor can be a percent of the original intensity of the pixel. The dimming factor is a variable; in a first order, the dimming factor varies as a function of distance from the bounding box. In a second order, the dimming factor has a rate of change that varies as it is applied across the background. The dimming factor is smaller adjacent to the person and larger at the periphery of the video frame.

### BACKGROUND

The display electronics and panel are among the most power-consuming components in a client device. A variety of poplar audio/video conferencing applications and video chat applications consume significant power via operation of the display electronics and panel. There is an ongoing desire to reduce power consumption, in order to improve battery life. Accordingly, continued reductions in power usage by display electronics and panels, particularly during audio/video conferencing, are desirable.

### BRIEF DESCRIPTION OF THE DRAWINGS

FIG. 1 is a schematic diagram illustrating an environment in which embodiments of the disclosure may be implemented.

FIG. 2 is an architectural block diagram of one or more application modules that may be operating in a system for management of display electronics during audio/video conferencing, in accordance with various embodiments.

FIG. 3A and FIG. 3B are visual aids for the discussion of the algorithms and tasks that the embodiments implement.

FIG. 4 illustrates a use case, in accordance with various embodiments.

FIG. 5 provides an exemplary a flow chart depicting an example method for management of display electronics during audio/video conferencing, in accordance with various embodiments.

FIG. 6 provides an exemplary method for management of display electronics during audio/video conferencing that is software-based.

FIG. 7 illustrates a timing controller as may be implemented in various embodiments.

FIG. 8 is a block diagram of an example compute node that may include any of the embodiments disclosed herein.

FIG. 9 illustrates a multi-processor environment in which embodiments may be implemented.

FIG. 10 is a block diagram of an example processor unit to execute computer-executable instructions as part of implementing technologies described herein.

### DETAILED DESCRIPTION

The display electronics and display panel driven by the display electronics are among the most power-consuming components in a client device, thereby adversely affecting battery life. It is anticipated that a new display technology of emissive display panels will be widely adopted for the display electronics in client devices. Some examples of emissive display panels include display panels using technologies such as organic light emitting diodes (OLED) and micro-LEDs. In addition, transmissive displays using mini-LEDs as backlight are also popular because of the high contrast range that they provide. Mini-LED displays are a technology that uses LEDs to backlight an LCD panel.

Because display electronics and the display panel driven by the display electronics see significant operation during a variety of popular audio/video conferencing and video chat applications, these popular audio/video conferencing and video chat applications consume significant power. Some non-limiting factors that drive this power consumption include the need to meet requirements for image resolution, contrast, brightness, refresh rates, and the like, while not sacrificing the transmission speed. Any reduction in power usage by the display electronics and the display panel driven by the display electronics can greatly enhance the battery life of client devices. Therefore, a technical challenge and opportunity is presented to reduce power consumption of the emissive display panels beyond existing display power conservation methods; specifically, during the use of the audio/video conferencing applications.

Some approaches using OLED technologies dim the edge of the display by a certain percentage in one or more layers. The disadvantage of this approach is that only the edges can be dimmed, so it is limited in power savings. Additionally, this solution does not proactively recognize, or leverage opportunities presented during audio/video conferencing to dim even more pixels.

Embodiments provide a solution to this technical challenge and related issues in the form of technologically enhanced systems and methods for management of display electronics during audio/video conferencing. As is described in more detail below, embodiments leverage opportunities presented during audio/video conferencing, such as the popular use of features like background blurring, background replacement filters, and the like, to dim pixels and reduce power consumption. In doing so, embodiments not only enhance the power efficiency of these display panels but also extend the battery life of the client devices.

Embodiments have the potential to save up to 50% of display power in a client device using emissive displays like OLED, micro-LED, and transmissive displays using mini-LEDs as backlight, which are an LCD panel technology that uses LED diodes to backlight a LCD display, in e.g. audio/video conferencing without any visual quality or user experience degradation. Embodiments achieve this by dimming pixels that are not actively used to display the user or any “meaningful” content, wherein meaningful is described in more detail below.

Some embodiments may exhibit a power consumption decrease of up to 50% during applications like audio/video conferencing. This can be observed, for example, by: (1) observing display power consumption in an active video conferencing call; or (2) recording the video conferencing call and playing the recorded video conference call to observe the operating power consumption. Additionally, optical sensors can be used to capture brightness and intensity while comparing an embodiment to a display panel that does not implement the embodiment. For example, if an image has a person wearing a white dress and the background has also some white content, the optical sensor can reveal that the white in the background will have less brightness than the dress.

As used herein, the terms “processor unit,” “processing circuitry,” “processing unit,” or “processor” may refer to any device or portion of a device that processes electronic data from registers and/or memory to transform that electronic data into other electronic data that may be stored in registers and/or memory. A processor unit may be a system-on-a-chip (SOC), and/or include one or more digital signal processor units (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processor units that execute cryptographic algorithms within hardware), server processor units, controllers, or any other suitable type of processor units. As such, the processor unit can be referred to as an XPU (or xPU).

As used herein, the term “module” may refer to any hardware, software, firmware, electronic control component, processing logic, and/or processor device, individually or in any combination. In various embodiments, a module is one or more of: an application specific integrated circuit (ASIC), a field-programmable gate-array (FPGA), an electronic circuit, a computer system comprising a processor (shared, dedicated, or group) and memory that executes one or more software or firmware programs, a combinational logic circuit, and/or other suitable components that provide the functionality attributed to the module.

For the sake of brevity, conventional techniques related to signal processing, data transmission, signaling, control, artificial intelligence (AI) models, machine learning models, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Embodiments of the present disclosure may be described herein in terms of functional and/or logical block components that perform different actions or tasks. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may conduct a variety of functions under the control of one or more microprocessors or other control devices.

As mentioned, audio and video conference applications and video chat applications, can operate with lower power consumption when using embodiments described herein. The technologically enhanced systems and methods for management of display electronics during audio/video conferencing are described in more detail in connection with the figures below.

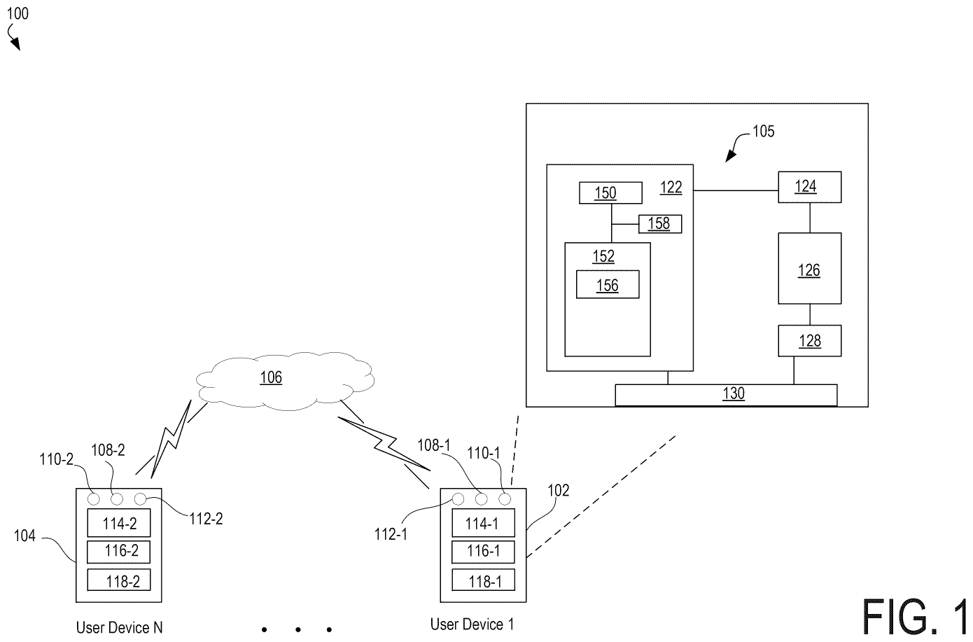

FIG. 1 is a schematic diagram depicting an example environment 100 in which embodiments may be implemented. A plurality of user devices, represented as user device 1 to user device N (N>1), may be communicatively coupled to one another via a network 106. A variety of different transmission protocols and architectures may be utilized in the network 106 and in support of the bidirectional communication between the user devices, such as, but not limited to, wireless, WIFI, 2G, 3G, 4G, 5G, etc.

The user devices are capable of transmitting and receiving media data comprising at least audio, video, and images; and, the user devices are configured, such as, with an installed device application, to run at least one media application that consumes and processes audio, video, and images. Some example media applications include audio and video conference applications and video chat applications. Accordingly, the user devices generally include at least a camera (108-1, 108-2), a speaker 110-1, 110-2, a microphone 112-1, 112-2, a display 114-1, 114-2, a user input device 116-1, 116-2 (e.g., a keyboard or touch screen), and a communication system 119-1, 118-2 that supports communication via the network 106. In various aspects of the disclosure, the network 106 includes a cloud server, not shown.

Although the user devices are drawn alike, in practice, they can be any combination of available computing devices that meet the above criteria. For example, the user devices can comprise any combination of laptop computers, desktop computers, kiosks, and cellular phones.

Various aspects of this disclosure are directed to a receive-side device. In an exemplary embodiment, User Device 1 is the receiving device, and a system for managing display electronics during audio/video conferencing, shown generally as system 105, is expanded out on the right in FIG. 1. The system 105 includes control circuit 122. In an exemplary embodiment, system 105 may further include a depacketization and demultiplexing system (demux) 124, a video encoding system 126, an encoding system 128, and a communication system 130. Other components, not shown to avoid clutter, may also be included in the receive-side device.

In operation, the system 105 may receive mixed media data signals Rx, process the video data signals Rx, as described herein, generate respective controls for display electronics, and cause images and video to be displayed on the user's device. As may be appreciated, the system 105 is to concurrently perform these operations for multiple users, such as during an audio/video conferencing or video chat application is in operation.

In various embodiments, as shown in FIG. 1, the control circuit 122 is realized as an enhanced computer system, comprising computer readable storage device or media, memory 152, for storage of instructions, algorithms, and/or programs, such as program 156 and a plurality of preprogrammed thresholds and parameters, the processor 150 to execute the program 156, and input/output interface (I/O) 158. The computer readable storage device or media, memory 152, may include volatile and nonvolatile storage in read-only memory (ROM), random-access memory (RAM), and keep-alive memory (KAM), for example. KAM is a persistent or non-volatile memory that may be used to store various operating variables while the processor 150 is powered down. The memory 152 may be implemented using any of several known memory devices such as PROMs (programmable read-only memory), EPROMS (electrically PROM), EEPROMs (electrically erasable PROM), flash memory, or any other electric, magnetic, optical, or combination memory devices capable of storing data, some of which represent executable instructions, used by the processor 150 in other aspects of server 120 operation. In various embodiments, processor 150 is to implement the system 105. The memory 152 may also be utilized by the processor 150 to cache data, to temporarily store results of comparisons and analyses, and the like. Information in the memory 152 may be organized and/or imported from an external source during an initialization or installment operation in a method; it may also be programmed via a user I/O interface.

The input/output interface (I/O) 158 may be operationally coupled to the processor 150 via a bus and enables intra-circuit 122 communication as well as extra-circuit 122 communication. The input/output interface (I/O) 158 may include one or more wired and/or wireless network interfaces and can be implemented using any suitable method and apparatus. In various embodiments, the input/output interface (I/O) 158 includes the hardware and software to support one or more communication protocols for wireless communication between the processor 150 and external sources, such as satellites, processing systems in the cloud, communication towers and ground stations. In various embodiments, the input/output interface (I/O) 122 supports communication with technicians, and/or one or more storage interfaces for direct connection to storage apparatuses.

During operation of the system 105, the processor 150 loads and executes one or more algorithms, instructions, and rules embodied as program 156, and, as such, controls the general operation of the system 105. During operation of the system 105, the processor 150 may receive data from external sources via the communication system 130. In various embodiments of the system 105, the control circuit 122 may: perform operations attributed to the system 105 in accordance with an algorithm; perform operations in accordance with state machine logic; and perform operations in accordance with logic in a programmable logic array.

While the exemplary embodiment of the system 105 is described in the context of the control circuit 122 implemented as a fully functioning enhanced computer system, those skilled in the art will recognize that the mechanisms of the present disclosure are capable of being distributed as computer-executable instructions or a computer program product (e.g., program 156) and predefined parameters. Such a program product may comprise an arrangement of instructions organized as multiple interdependent program code modules, each configured to achieve a separate process and/or perform a separate algorithmic operation, arranged to manage data flow through the system 105. The program code modules may each comprise an ordered listing of executable instructions or rules for implementing logical functions for the processes performed by the system 105. The instructions in the program code modules, when executed by a processor (e.g., processor 150), cause the processor to receive and process signals, and perform logic, calculations, methods and/or algorithms as described herein. Such a program product may take a variety of forms, and the present disclosure applies equally regardless of the type of computer-readable signal bearing media used to carry out the distribution.

As mentioned, the first user device 102 is designated as a reference device or receive-side device, to distinguish it from a plurality of other user's devices participating in a mixed media application or conference call. It may be appreciated that, in operation, the techniques and methods described for the receive-side user may be employed for every user participating in the conference call or mixed media application.

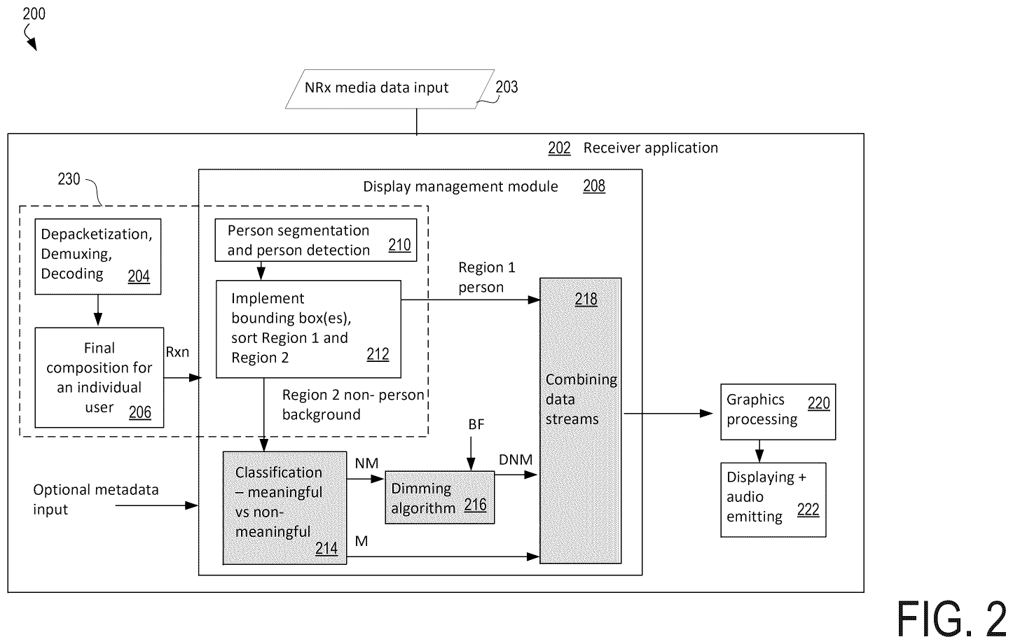

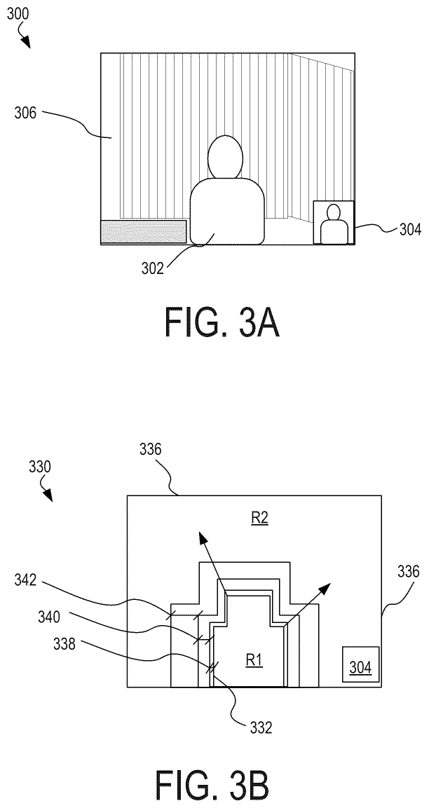

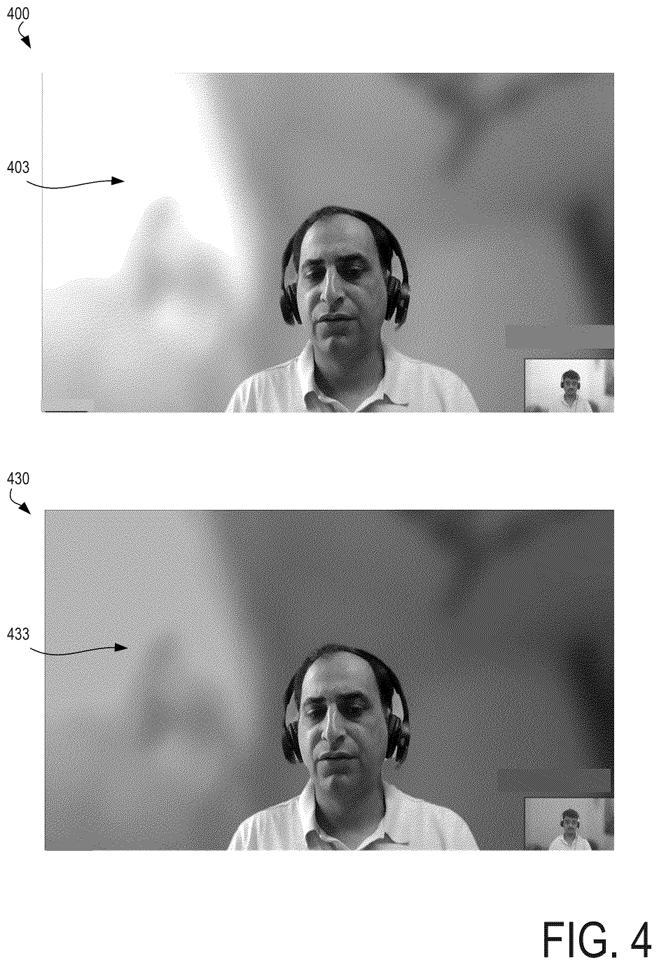

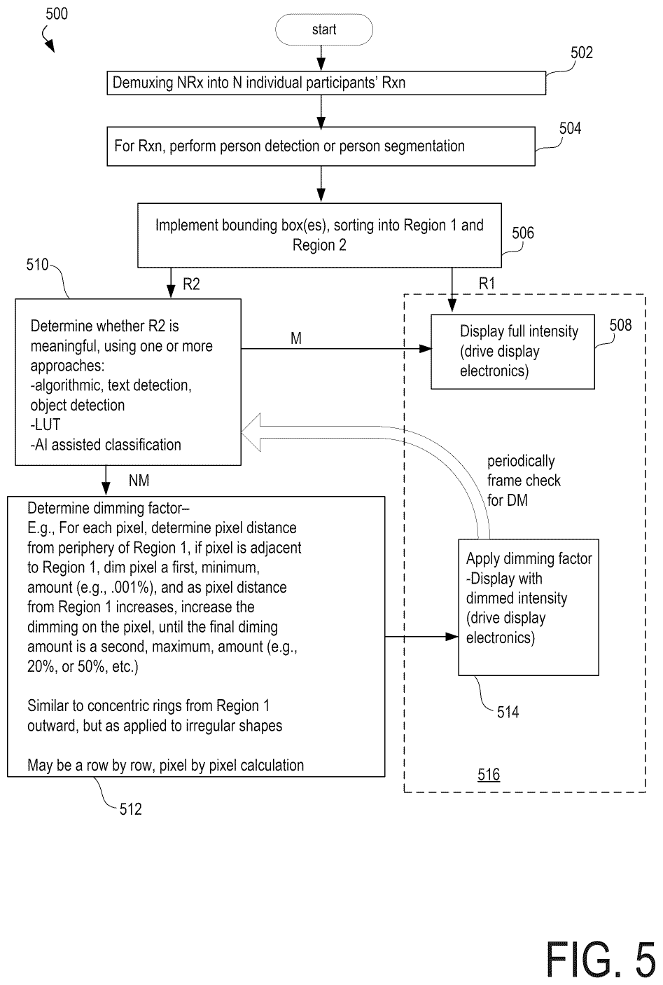

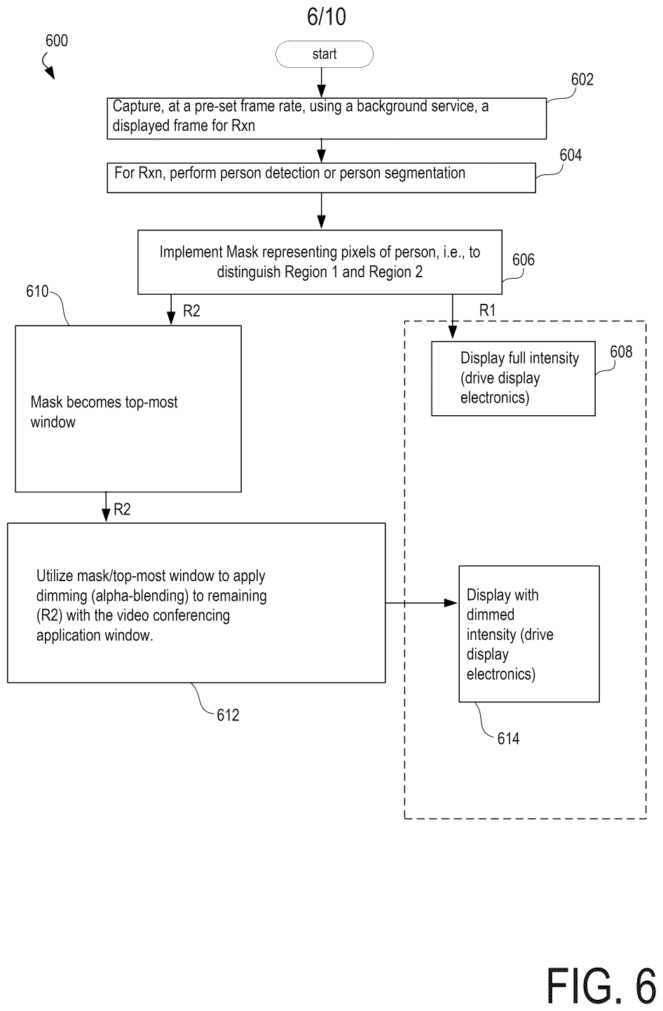

With continued reference to FIG. 1, FIGS. 2-6 are now addressed. Exemplary application process modules of the system 105 are described in connection with FIG. 2. FIG. 3A and FIG. 3B are visual aids for the discussion of the algorithms that the system 105 implements and FIG. 4 illustrates a use case. FIG. 5 provides an exemplary method 500 for operating the system 105 is described in connection with FIG. 1 and FIG. 2, and FIG. 6 provides an exemplary method for management of display electronics during audio/video conferencing that is software-based.

FIG. 2 provides a non-limiting example for an organization of application process modules in the system 105. In an application, each application module may be realized as one or more sub-modules, and the modules and sub-modules may be distributed among and between various server and/or device systems and components. In the example, there are N user devices in operational communication with the receiver application module 202, providing NRx data input 203. The N user devices are also referred to as external devices. The NRx are mixed media data signals. In various applications, the individual Rx are audio/video conferencing data or video chat data.

A depacketization, decoding and demultiplexing (shortened herein to demuxing) module 204 receives NRx data input 203, which is a combined media stream (i.e., combined mixed media data signals) that includes video signals, audio signals, and images or profile pictures for N users (the N users do not include duplicate users) via their respective user devices. The demuxing module 204 sorts the NRx signal into its N constituent data streams, Rxn. A composition module 206 synchronizes the data and generates a final composition video Rxn for an individual user (external user).

A display management module 208 in the receiver application module operates on the video data for the individual external user. The display management module may operate in accordance with method 500. For illustrative purposes, the following description of method 500 may refer to elements mentioned above in connection with FIGS. 1, 2, 3A, 3B, and 4. In various embodiments, portions of method 500 may be performed by different components of the described system 105. It should be appreciated that method 500 may include any number of additional or alternative operations and tasks, the tasks shown in FIG. 5 need not be performed in the illustrated order, and method 500 may be incorporated into a more comprehensive procedure or method, such as a video conference call application, having additional functionality not described in detail herein. Moreover, one or more of the tasks shown in FIG. 5 could be omitted from an embodiment of the method 500 if the intended overall functionality remains intact.

At 502, the received multi-media data NRx is decoded, depacketized, and demuxed into Rxn, as described above.

At 504, person segmentation or person detection are performed, e.g., by module 210. In various aspects of the disclosure, person segmentation or person detection are performed as known in the industry, for example, using polygons or boxes. As an example, in FIG. 3A, a simplified video frame 300 shows first user 302 in a video conferencing application, and a small video inset 304 showing another (external) user in the video conferencing application. As used herein, the video frame 300 may be a full video frame or comprise incremental video data sufficient to perform a bounding box operation (at 506). The simplified background 306 depicts vertical panels and a grey tabletop. The display management module converts the video frame 300 using bounding boxes (at 506) by labeling the person-bounded region(s) as region 1 (R1) and the non-person regions as region 2 (R2).

The bounding box delineates the person or R1 from the background or R2, and this bounding box can be of any geometric shape, e.g. n-sided polygon, curved shape, or using depth information for foreground/background separation. The system 105 displays a converted video frame in which R1 has pixels displayed at full original intensity, or said differently, the system 105 controls the display electronics such that they are unchanged for R1. R2 is what is also referred to as background, the pixels that are associated with the background are subjected to further scrutiny.

A means for classification, or a classification module 214 operates on R2 (at 510) to determine whether the background is meaningful (determined meaningful=M) or non-meaningful (determined non-meaningful=NM). Meaningful backgrounds are displayed by system 105 with pixels at full intensity, as are the region 1 pixels, i.e., their intensities are unchanged from their original pixel intensity. Pixels associated with meaningful backgrounds may also be displayed by the system 105 with full refresh rate as are the region 1 pixels, which may be a higher refresh rate than pixels associated with non-meaningful backgrounds.

In various aspects of the disclosure, the classification module 214 may utilize text recognition algorithms and/or object recognition algorithms. In an embodiment, the classification module 214 or means for classification may further include a set of rules encoded in the program 156. In another embodiment, the classification module 214 or means for classification may further include a lookup table. For example, see Table 1, below.

TABLE 1
example lookup table

| Detected | Meaningful | Non-meaningful |
|---|---|---|
| Background blur filter is on | | X |
| Featureless wall | | X |
| Featureless ceiling | | X |
| Text on an object | X | |
| Books | X | |
| Dynamic background | X | |

In some embodiments, at 510, machine learning or an artificial intelligence (AI) module may be used in the classification module 214 or means for classification. For example, a test data set can be generated to train an AI module to classify the contents in R2. Use of an AI module in this way may enhance the speed and performance of the system 105.

After identifying a non-meaningful (NM) region 2 or background, the embodiments proceed to apply a dimming algorithm at 512 (indicated with dimming module 216). With reference to FIG. 3B, the simplified video frame 330 shows that the first user has been segmented and sorted as region 1 (R1) and the background has been sorted as region 2 (R2). The video inset 304 is another region 1, to remain unchanged (i.e., will be displayed at full original pixel intensity) in the output converted video frame/display. As may be appreciated, the full video frame 330 is indicated with a rectangle.

The dimming module 216 operations may also be viewed as a means for managing display electronics. In an embodiment, the dimming module 216 or means for managing display electronics begins with the bounding box 332 which is placed around the periphery of person as described herein, and a dimming factor or dimming amount for an individual pixel is determined based on a distance that the pixel is away from the bounding box 332. In a simplified way, it can be thought of as concentric rings emanating radially outward from the bounding box 332, but as applied to an irregular shape, as illustrated. In this aspect, the dimming factor is a function of distance from the bounding box.

The pixels are dimmed by a dimming factor, and the dimming factor ranges from a minimum amount to a maximum amount. In a non-limiting example, moving on a row by row, and pixel by pixel manner through the data in the video frame 330, for each pixel, determine a pixel distance from the periphery of Region 1, and determine a respective dimming factor based thereon. If the pixel is adjacent to Region 1, the dimming factor is a first, minimum, amount (e.g., 0.001%), as the pixel distance from Region 1 increases, the dimming factor increases, until, at the edge 336 of the video frame, the diming factor is a second, maximum, amount (e.g., 20%, or 50%, etc.). In an embodiment, the pixels are dimmed non-linearly between Region 1 bounding box and the edge 336 or periphery of the video frame. In a non-limiting example, the minimum amount is in a range of 0.001% to 0.01% and the maximum amount is in a range of 20% to 50%.

In another non-limiting example, the dimming factor further has a rate of change that is at least 20% higher adjacent to the bounding box (i.e., near the person) than the rate of change at the edge or the periphery of the video frame. For example, the system may implement the dimming factor by changing it more frequently closer in the bounding lines that are closer to the bounding box than at bounding lines that are near the periphery of the video frame. The dimming factor is applied to the original intensity pixel by the system 105 to result in a dimmed pixel, and the system 105 drives the display electronics (at 514) to display a converted video frame in the audio/video application that includes the collective dimmed pixel data combined with the original intensity pixel data from R1. An advantage of this methodology is that it creates a smooth visual transition adjacent to the person or R1 and the farther away from R1 the pixels are (i.e., the more into the non-meaningful area, R2), the more quickly the system 105 transitions from high original intensity pixel display to low (dimmed) pixel intensity, which promotes a lowest power configuration.

Dimmed non-meaningful (DNM) data may be combined with un-dimmed, original intensity pixel data (i.e., R1 and M R2 data), e.g., by a combining module 218, and output from the combining module can be used to drive graphics processing (e.g., a graphics processing module 220) and or be directly applied (at 516) to the display electronics in a display module 222 to display a resulting converted video frame. In various aspects of the disclosure, when a previously supplied and asserted blur flag (BF) is de-asserted, the system 105 may return to classifying the background with classification module 214 or means for classification. Likewise, when previously supplied metadata that included the identification of region 1 (the person), the bounding box, and the identification of region 2 (the background) is thereafter withdrawn, responsive thereto, the system 105 can return to operating by performing person segmentation and person detection (module 210) and to thereby generate the bounding box for the video frame as described herein.

Periodically, the system 105 may perform a video frame check to determine whether an R2 that was previously determined to be NM (non-meaningful) has changed to be meaningful (M). In some non-limiting examples, this periodicity can be every 10th frame, every 1-2 seconds, or whatever is suitable to meet power requirements. Upon determining that the background has become meaningful (or upon de-assertion of a blur flag, as described above), the system 105 may cease applying the dimming factors and drive the display electronics with the respective full original pixel intensities in the video frame. In various embodiments, the system 105 also determines whether the user is operating the audio/video conferencing application in a foreground mode of the user's device, and if not, the system 105 may cease driving the display electronics.

As mentioned above, in some embodiments, the dimming module changes the rate of change of the dimming factor as it is applied to individual pixels in the R2 area. For example, the rate of change of the dimming factor may be lowest closest to the bounding box 332 and successive bounding lines away from region 1 can have a dimming factor that exhibits a faster and faster rate of change. This functionality may be referred to as a frequency of determination of the dimming factor, and is indicated in the image as follows: Note that a first distance between a bounding line 338 and the bounding box 332 is smaller than a second distance between the bounding line 340 and the bounding line 338, and the second distance is in turn smaller than a third distance between the bounding line 340 and the bounding line 342; this corresponds to a small rate of change at the first distance, a faster rate of change at the second distance, and an even faster rate of change at the third distance. An advantage of this methodology is that it creates a smooth visual transition adjacent to the person or R1 and the farther away from R1 the pixels are, the more quickly they descend from high original intensity pixel display to low (dimmed) pixel intensity, in remaining portions of R2, which promotes a lowest power configuration and operation of the system 105.

In an optional configuration, the modules within the dashed box in FIG. 2 may be performed prior to data arrival at the receiver side application, such as, by a cloud server or application server. In some embodiments, the receiver application module 202 may receive optional metadata input. The metadata input may include a blur flag (BF) that notifies the receiver application module 202 that the background has been blurred by the user, filtered by the user, or similar. The metadata may also include the bounding boxes with a R1 and R2 already defined. In an embodiment in which the metadata provides the bounding box, distinguishing the person from the background, the system 105 can proceed to the classification module 214. In an embodiment that provides the blur flag (BF), the system can proceed to the dimming algorithm represented by dimming module 216. In such cases, this information can be processed promptly by the display management module 208, and operations previously attributed to module 210 and module 212 may be omitted from operations performed by the system 105.

Note that even when the external user or sending person has enabled a background blur or background filter, embodiments of the system 105 can still reduce power with the dimming operations of dimming module 216. FIG. 4 provides an illustration of this. In video image 400, it is observable that the background has been blurred. Video image 430 shows the output of the dimming module 216; specifically, it is observable that the region 403 in video image 400 has more white and crisper shadows than the corresponding region 433 in video image 430.

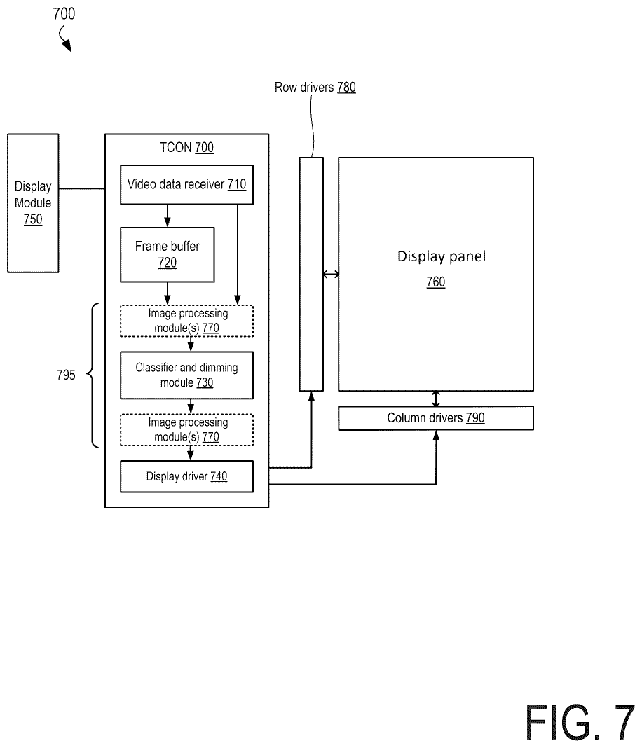

Much of this discussion has been directed to a hardware or hardware/software combined application, as may be implemented in a timing controller (see, FIG. 7, TCON 700, described in more detail below) on a user device, however at least some of the herein described features can also be implemented in a software program. With reference to FIG. 6, another method 600 for management of display electronics during audio/video conferencing is illustrated.

At 602, using a pre-set frame rate, a background service software can capture a displayed frame, Rxn. At 604, person detection or person segmentation can be performed as described above. At 606, the software can generate a mask representing pixels of the person to distinguish the R1 and R2 regions. This mask can operate like an invisible top-most window that sends R1 for full intensity display (at 608) and sends R2 background frame data to a dimming algorithm at 610. At 612, an alpha-blending routine may apply a dimming factor to the background in the video conferencing application window. The dashed line indicates a hardware or display electronics receiver for the software generated dimmed R2.

FIG. 7 illustrates a block diagram of an example timing controller 700 comprising a classifier and dimming module 730. The timing controller 700 comprises a video data receiver 710, a frame buffer 720, the classification and dimming module 730, and a display driver 740. The timing controller 700 receives video data from a display module 750 located in a base of a mobile computing device and drives a display panel 760. The timing controller 700 and the display panel 760 can be located in a lid of a client mobile computing device (e.g., user device 102). The display driver 740 drives display panel controller circuitry, such as row drivers 780 and column drivers 790.

The classification and dimming module 730 enable the power consumed by the display panel 760 to be reduced by globally dimming the images to be displayed as described above. In some embodiments, one or more image processing modules 770 are located before and/or after the classification and dimming module 730 in the stack 795. The image processing modules 770 can perform various image processing operations as are available on the client device.

Thus, systems and methods for management of display electronics during audio/video conferencing have been provided. Embodiments advantageously reduce power consumption during conference calls and other mixed media applications. The following additional figures and description are intended to illustrate various contexts for usage and application of the present disclosure.

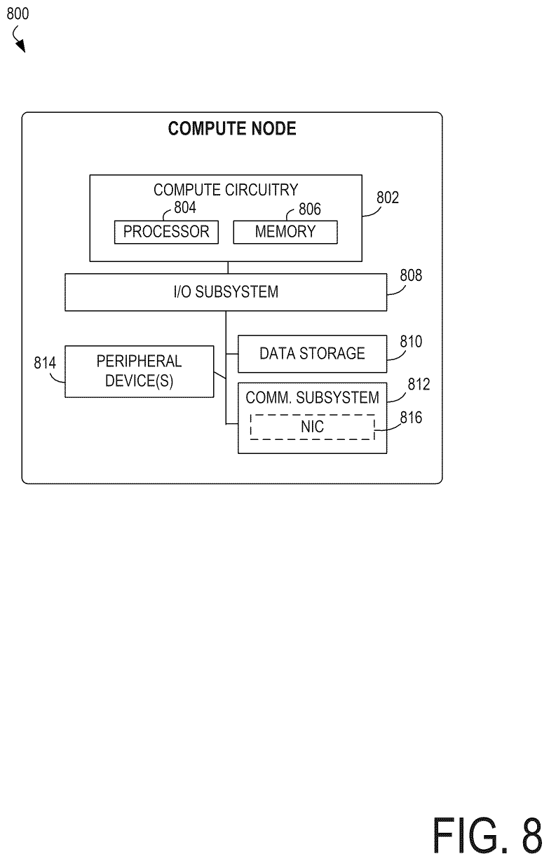

Disclosed embodiments may be implemented in a compute node. In the simplified example depicted in FIG. 8, a compute node 800 includes a compute engine (referred to herein as “compute circuitry”) 802, an input/output (I/O) subsystem 808, data storage device 810, a communication circuitry subsystem 812, and, optionally, one or more peripheral devices 814. With respect to the present example, the compute node 800 or compute circuitry 802 may perform the operations and tasks attributed to the system 105. In other examples, respective compute nodes 800 may include other or additional components, such as those typically found in a computer (e.g., a display, peripheral devices, etc.). Additionally, in some examples, one or more of the illustrative components may be incorporated in, or otherwise form a portion of, another component.

In some examples, the compute node 800 may be embodied as a single device such as an integrated circuit, an embedded system, a field-programmable gate array (FPGA), a system-on-a-chip (SOC), or other integrated system or device. In the illustrative example, the compute node 800 includes or is embodied as a processor 804 and a memory 806. The processor 804 may be embodied as any type of processor capable of performing the functions described herein (e.g., executing compile functions and executing an application). For example, the processor 804 may be embodied as a multi-core processor(s), a microcontroller, a processing unit, a specialized or special purpose processing unit, or other processor or processing/controlling circuit.

In some examples, the processor 804 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 804 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing, or managing server or data center hardware, managing service meshes, or collecting and distributing telemetry), outside of the CPU or general-purpose processing hardware. However, it will be understood that a xPU, a SOC, a CPU, and other variations of the processor 804 may work in coordination with each other to execute many types of operations and instructions within and on behalf of the compute node 800.

The memory 806 may be embodied as any type of volatile (e.g., dynamic random-access memory (DRAM), etc.) or non-volatile memory or data storage capable of performing the functions described herein. Volatile memory may be a storage media that requires power to maintain the state of data stored by the media. Non-limiting examples of volatile memory may include diverse types of random-access memory (RAM), such as DRAM or static random-access memory (SRAM). One type of DRAM that may be used in a memory module is synchronous dynamic random-access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 806 may be integrated into the processor 804. The memory 806 may store various software and data used during operation such as one or more applications, data operated on by the application(s), libraries, and drivers.

The compute circuitry 802 is communicatively coupled to other components of the compute node 800 via the I/O subsystem 808, which may be embodied as circuitry and/or components to facilitate input/output operations with the compute circuitry 802 (e.g., with the processor 804 and/or the main memory 806) and other components of the compute circuitry 802. For example, the I/O subsystem 808 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 808 may form a portion of a system-on-a-chip (SoC) and be incorporated, along with one or more of the processor 804, the memory 806, and other components of the compute circuitry 802, into the compute circuitry 802.

The one or more illustrative data storage devices 810 may be embodied as any type of devices configured for short-term or long-term storage of data such as, for example, memory devices and circuits, memory cards, hard disk drives, solid-state drives, or other data storage devices. Individual data storage devices 810 may include a system partition that stores data and firmware code for the data storage device 810. Individual data storage devices 810 may also include one or more operating system partitions that store data files and executables for operating systems depending on, for example, the type of compute node 800.

The communication subsystem 812 may be embodied as any communication circuit, device, transceiver circuit, or collection thereof, capable of enabling communications over a network between the compute circuitry 802 and another computing device (e.g., an edge gateway of an implementing edge computing system).

The communication subsystem 812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication subsystem 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication subsystem 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication subsystem 812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication subsystem 812 may operate in accordance with other wireless protocols in other embodiments. The communication subsystem 812 may include an antenna to facilitate wireless communications and/or to receive other wireless communications (such as AM or FM radio transmissions).

In some embodiments, the communication subsystem 812 may manage wired communications, such as electrical, optical, or any other suitable communication protocols (e.g., IEEE 802.3 Ethernet standards). As noted above, the communication subsystem 812 may include multiple communication components. For instance, a first communication subsystem 812 may be dedicated to shorter-range wireless communications such as Wi-Fi or Bluetooth, and a second communication subsystem 812 may be dedicated to longer-range wireless communications such as global positioning system (GPS), EDGE, GPRS, CDMA, WiMAX, LTE, EV-DO, or others. In some embodiments, a first communication subsystem 812 may be dedicated to wireless communications, and a second communication subsystem 812 may be dedicated to wired communications.

The illustrative communication subsystem 812 includes an optional network interface controller (NIC) 820, which may also be referred to as a host fabric interface (HFI). The NIC 820 may be embodied as one or more add-in-boards, daughter cards, network interface cards, controller chips, chipsets, or other devices that may be used by the compute node 800 to connect with another computing device (e.g., an edge gateway node). In some examples, the NIC 820 may be embodied as part of a system-on-a-chip (SoC) that includes one or more processor units or included on a multichip package that also contains one or more processor units. In some examples, the NIC 820 may include a local processor (not shown) and/or a local memory (not shown) that are both local to the NIC 820. In such examples, the local processor of the NIC 820 may be capable of performing one or more of the functions of the compute circuitry 802 described herein. Additionally, or alternatively, in such examples, the local memory of the NIC 820 may be integrated into one or more components of the client compute node at the board level, socket level, chip level, and/or other levels.

Additionally, in some examples, a respective compute node 800 may include one or more peripheral devices 814. Such peripheral devices 814 may include any type of peripheral device found in a computing device or server such as audio input devices, a display, other input/output devices, interface devices, and/or other peripheral devices, depending on the particular type of the compute node 800. In further examples, the compute node 800 may be embodied by a respective edge compute node (whether a client, gateway, or aggregation node) in an edge computing system or like forms of appliances, computers, subsystems, circuitry, or other components.

In other examples, the compute node 800 may be embodied as any type of device or collection of devices capable of performing various compute functions. Respective compute nodes 800 may be embodied as a type of device, appliance, computer, or other “thing” capable of communicating with other compute nodes that may be edge, networking, or endpoint components. For example, a compute node may be embodied as a personal computer, server, smartphone, a mobile computing device, a smart appliance, smart camera, an in-vehicle compute system (e.g., a navigation system), a weatherproof or weather-sealed computing appliance, a self-contained device within an outer case, shell, etc., or other device or system capable of performing the described functions.

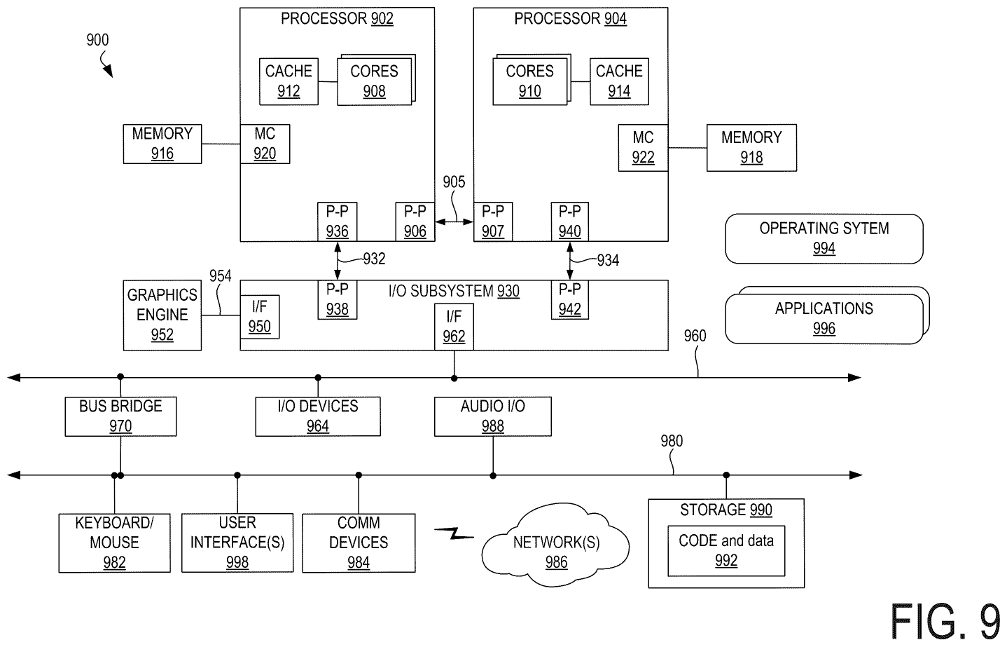

FIG. 9 illustrates a multi-processor environment in which embodiments may be implemented. Processor units 902 and 904 further comprise cache memories 912 and 914, respectively. The cache memories 912 and 914 can store data (e.g., instructions) utilized by one or more components of the processor units 902 and 904, such as the processor cores 908 and 910. The cache memories 912 and 914 can be part of a memory hierarchy for the computing system 900. For example, the cache memories 912 can locally store data that is also stored in a memory 916 to allow for faster access to the data by the processor unit 902. In some embodiments, the cache memories 912 and 914 can comprise multiple cache levels, such as level 1 (L1), level 2 (L2), level 3 (L3), level 4 (L4) and/or other cache memories or cache levels. In some embodiments, one or more levels of cache memory (e.g., L2, L3, L4) can be shared among multiple cores in a processor unit or among multiple processor units in an integrated circuit component. In some embodiments, the last level of cache memory on an integrated circuit component can be referred to as a last level cache (LLC). One or more of the higher levels of cache levels (the smaller and faster cache memories) in the memory hierarchy can be located on the same integrated circuit die as a processor core and one or more of the lower cache levels (the larger and slower cache memories) can be located on an integrated circuit dies that are physically separate from the processor core integrated circuit dies.

Although the computing system 900 is shown with two processor units, the computing system 900 can comprise any number of processor units. Further, a processor unit can comprise any number of processor cores. A processor unit can take various forms such as a central processing unit (CPU), a graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other types of processing units. As such, the processor unit can be referred to as an XPU (or xPU). Further, a processor unit can comprise one or more of these diverse types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 900 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The processor units 902 and 904 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from the integrated circuit dies comprising the processor units. In some embodiments, these separate integrated circuit dies can be referred to as “chiplets”. In some embodiments where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Processor units 902 and 904 further comprise memory controller logic (MC) 920 and 922. As shown in FIG. 9, MCs 920 and 922 control memories 916 and 918 coupled to the processor units 902 and 904, respectively. The memories 916 and 918 can comprise various types of volatile memory (e.g., dynamic random-access memory (DRAM), static random-access memory (SRAM)) and/or non-volatile memory (e.g., flash memory, chalcogenide-based phase-change non-volatile memories), and comprise one or more layers of the memory hierarchy of the computing system. While MCs 920 and 922 are illustrated as being integrated into the processor units 902 and 904, in alternative embodiments, the MCs can be external to a processor unit.

Processor units 902 and 904 are coupled to an Input/Output (I/O) subsystem 930 via point-to-point interconnections 932 and 934. The point-to-point interconnection 932 connects a point-to-point interface 936 of the processor unit 902 with a point-to-point interface 938 of the I/O subsystem 930, and the point-to-point interconnection 934 connects a point-to-point interface 940 of the processor unit 904 with a point-to-point interface 942 of the I/O subsystem 930. Input/Output subsystem 930 further includes an interface 950 to couple the I/O subsystem 930 to a graphics engine 952. The I/O subsystem 930 and the graphics engine 952 are coupled via a bus 954.

The Input/Output subsystem 930 is further coupled to a first bus 960 via an interface 962. The first bus 960 can be a Peripheral Component Interconnect Express (PCIe) bus or any other type of bus. Various I/O devices 964 can be coupled to the first bus 960. A bus bridge 970 can couple the first bus 960 to a second bus 980. In some embodiments, the second bus 980 can be a low pin count (LPC) bus. Various devices can be coupled to the second bus 980 including, for example, a keyboard/mouse 982, audio I/O devices 988, and a storage device 990, such as a hard disk drive, solid-state drive, or another storage device for storing computer-executable instructions (code) 992 or data. The code 992 can comprise computer-executable instructions for performing methods described herein. Additional components that can be coupled to the second bus 980 include communication device(s) 984, which can provide for communication between the computing system 900 and one or more wired or wireless networks 986 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

In embodiments where the communication devices 984 support wireless communication, the communication devices 984 can comprise wireless communication components coupled to one or more antennas to support communication between the computing system 900 and external devices. The wireless communication components can support various wireless communication protocols and technologies such as Near Field Communication (NFC), IEEE 802.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The system 900 can comprise removable memory such as flash memory cards (e.g., SD (Secure Digital) cards), memory sticks, Subscriber Identity Module (SIM) cards). The memory in system 900 (including cache memories 912 and 914, memories 916 and 918, and storage device 990) can store data and/or computer-executable instructions for executing an operating system 994 and application programs 996. Example data includes web pages, text messages, images, sound files, and video data biometric thresholds for particular users or other data sets to be sent to and/or received from one or more network servers or other devices by the system 900 via the one or more wired or wireless networks 986, or for use by the system 900. The system 900 can also have access to external memory or storage (not shown) such as external hard drives or cloud-based storage.

The operating system 994 (also simplified to “OS” herein) can control the allocation and usage of the components illustrated in FIG. 6 and support the one or more application programs 996. The application programs 996 can include common computing system applications (e.g., email applications, calendars, contact managers, web browsers, messaging applications) as well as other computing applications.

In some embodiments, a hypervisor (or virtual machine manager) operates on the operating system 994 and the application programs 996 operate within one or more virtual machines operating on the hypervisor. In these embodiments, the hypervisor is a type-2 or hosted hypervisor as it is running on the operating system 994. In other hypervisor-based embodiments, the hypervisor is a type-1 or “bare-metal” hypervisor that runs directly on the platform resources of the computing system 994 without an intervening operating system layer.

In some embodiments, the application programs 996 can operate within one or more containers. A container is a running instance of a container image, which is a package of binary images for one or more of the application programs 996 and any libraries, configuration settings, and any other information that one or more application programs 996 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 994. An orchestrator can be responsible for management of the computing system 900 and various container-related tasks such as deploying container images to the computing system 994, monitoring the performance of deployed containers, and monitoring the utilization of the resources of the computing system 994.

The computing system 900 can support various additional input devices, represented generally as user interfaces 998, such as a touchscreen, microphone, monoscopic camera, stereoscopic camera, trackball, touchpad, trackpad, proximity sensor, light sensor, electrocardiogram (ECG) sensor, PPG (photoplethysmogram) sensor, galvanic skin response sensor, and one or more output devices, such as one or more speakers or displays. Other possible input and output devices include piezoelectric and other haptic I/O devices. Any of the input or output devices can be internal to, external to, or removably attachable with the system 900. External input and output devices can communicate with the system 900 via wired or wireless connections.

In addition, one or more of the user interfaces 998 may be natural user interfaces (NUIs). For example, the operating system 994 or application programs 996 can comprise speech recognition logic as part of a voice user interface that allows a user to operate the system 900 via voice commands. Further, the computing system 900 can comprise input devices and logic that allows a user to interact with computing the system 900 via body, hand, or face gestures. For example, a user's hand gestures can be detected and interpreted to provide input to a gaming application.

The I/O devices 964 can include at least one input/output port comprising physical connectors (e.g., USB, IEEE 1394 (Fire Wire), Ethernet, RS-232), a power supply (e.g., battery), a global satellite navigation system (GNSS) receiver (e.g., GPS receiver); a gyroscope; an accelerometer; and/or a compass. A GNSS receiver can be coupled to a GNSS antenna. The computing system 900 can further comprise one or more additional antennas coupled to one or more additional receivers, transmitters, and/or transceivers to enable additional functions.

In addition to those already discussed, integrated circuit components, integrated circuit constituent components, and other components in the computing system 994 can communicate with interconnect technologies such as Intel® QuickPath Interconnect (QPI), Intel® Ultra Path Interconnect (UPI), Computer Express Link (CXL), cache coherent interconnect for accelerators (CCIX®), serializer/deserializer (SERDES), Nvidia® NVLink, ARM Infinity Link, Gen-Z, or Open Coherent Accelerator Processor Interface (OpenCAPI). Other interconnect technologies may be used and a computing system 994 may utilize more or more interconnect technologies.

It is to be understood that FIG. 9 illustrates only one example computing system architecture. Computing systems based on alternative architectures can be used to implement technologies described herein. For example, instead of the processor units 902 and 904 and the graphics engine 952 being located on discrete integrated circuits, a computing system can comprise an SoC (system-on-a-chip) integrated circuit incorporating multiple processor units, a graphics engine, and additional components. Further, a computing system can connect its constituent component via bus or point-to-point configurations different from that shown in FIG. 9. Moreover, the illustrated components in FIG. 9 are not required or all-inclusive, as shown components can be removed and other components added in alternative embodiments.

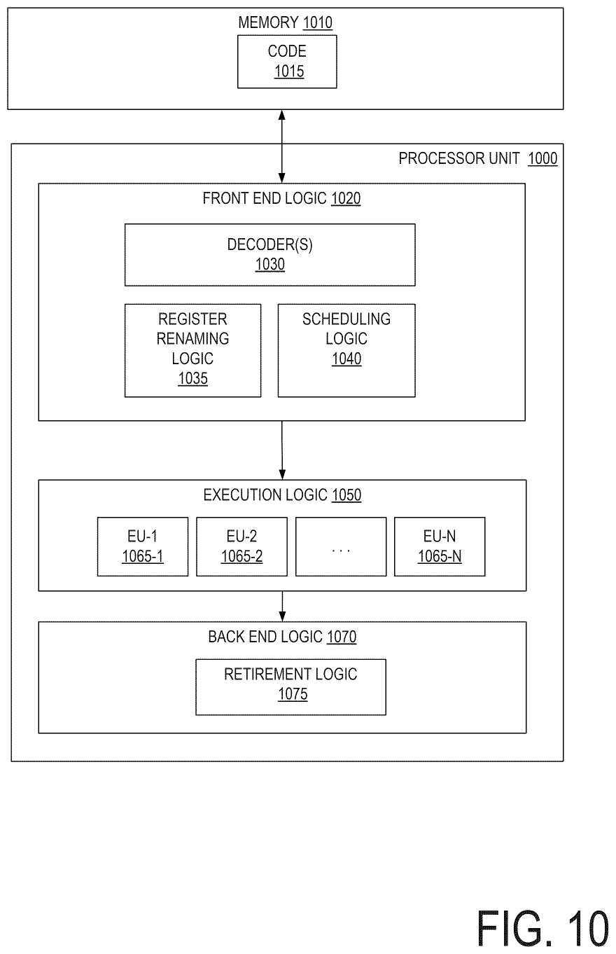

FIG. 10 is a block diagram of an example processor unit 1000 to execute computer-executable instructions as part of implementing technologies described herein. The processor unit 1000 can be a single-threaded core or a multithreaded core in that it may include more than one hardware thread context (or “logical processor”) per processor unit.

FIG. 10 also illustrates a memory 1010 coupled to the processor unit 1000. The memory 1010 can be any memory described herein or any other memory known to those of skill in the art. The memory 1010 can store computer-executable instructions 1015 (code) executable by the processor unit 1000.

The processor unit comprises front-end logic 1020 that receives instructions from the memory 1010. An instruction can be processed by one or more decoders 1030. The decoder 1030 can generate as its output a micro-operation such as a fixed width micro-operation in a predefined format, or generate other instructions, microinstructions, or control signals, which reflect the original code instruction. The front-end logic 1020 further comprises register renaming logic 1035 and scheduling logic 1040, which generally allocate resources and queues operations corresponding to converting an instruction for execution.

The processor unit 1000 further comprises execution logic 1050, which comprises one or more execution units (EUs) 1065-1 through 1065-N. Some processor unit embodiments can include a few execution units dedicated to specific functions or sets of functions. Other embodiments can include only one execution unit or one execution unit that can perform a particular function. The execution logic 1050 performs the operations specified by code instructions. After completion of execution of the operations specified by the code instructions, back-end logic 1070 retires instructions using retirement logic 1075. In some embodiments, the processor unit 1000 allows out of order execution but requires in-order retirement of instructions. Retirement logic 1075 can take a variety of forms as known to those of skill in the art (e.g., re-order buffers or the like).

The processor unit 1000 is transformed during execution of instructions, at least in terms of the output generated by the decoder 1030, hardware registers and tables utilized by the register renaming logic 1035, and any registers (not shown) modified by the execution logic 1050.

While at least one embodiment has been presented in the foregoing detailed description, it should be appreciated that a vast number of variations exist. It should also be appreciated that the disclosed embodiments are only examples, and are not intended to limit the scope, applicability, or configuration of the disclosure in any way. Rather, the foregoing detailed description will provide those skilled in the art with a convenient road map for implementing the disclosed aspects of the present disclosure. Various changes can be made in the function and arrangement of elements without departing from the scope of the disclosure as set forth in the appended claims and the legal equivalents thereof.

As used herein, a “computer,” “computing system,” or “compute device” refers to any of a variety of computing devices and includes systems comprising multiple discrete physical components capable of executing instructions. In some embodiments, the computing systems are located in a data center, such as an enterprise data center (e.g., a data center owned and operated by a company and typically located on company premises), managed services data center (e.g., a data center managed by a third party on behalf of a company), a collocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

Thus, the term “computer-executable instruction” refers to instructions that can be executed by any computing system, device, or machine described or mentioned herein as well as any other computing system, device, or machine capable of executing instructions. As mentioned, any of the disclosed methods (or a portion thereof) can be implemented as computer-executable instructions or a computer program product. Such instructions can cause a computing system or one or more processor units capable of executing computer-executable instructions to perform any of the disclosed methods.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

Additionally, theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

As used herein, phrases such as “embodiments,” “an aspect of the present disclosure,” “various aspects of the present disclosure,” “some aspects of the present disclosure,” and the like, indicate that some aspects of the present disclosure may have some, all, or none of the features described for other aspects of the present disclosure. “First,” “second,” “third,” and the like describe a common object and indicate different instances of like objects being referred to; unless specifically stated, they do not imply a given sequence, either temporally or spatially, in ranking, or any other manner. In accordance with patent application parlance, “connected” indicates elements that are in direct physical or electrical contact with each other and “coupled” indicates elements that co-operate or interact with each other, coupled elements may or may not be in direct physical or electrical contact. Furthermore, the terms “comprising,” “including,” “having,” and the like, are utilized synonymously to denote non-exclusive inclusions.

As used in this application and the claims, a list of items joined by the term “at least one of” can mean any combination of the listed terms. For example, the phrase “at least one of A, B and C” can mean A; B; C; A and B; A and C; B and C; or A, B, and C. Similarly, as used in this application and the claims, a list of items joined by the term “one or more of” can mean any combination of the listed terms. For example, the phrase “one or more of A, B and C” can mean A; B; C; A and B; A and C; B and C; or A, B, and C.

The following Examples pertain to additional aspects of the present disclosure of technologies disclosed herein.

### EXAMPLES

Example 1 is a system, comprising: a display component on a user device; and a control circuit coupled to the display component, the control circuit to: receive a mixed media data signal from an external device; create a video frame from the mixed media data signal; delineate a person in the video frame from a background with a bounding box; determine that the background is not meaningful; wherein the video frame comprises, for a plurality of pixels, a respective original pixel intensity; identify pixels of the plurality of pixels that are associated with the background as background pixels; for individual background pixels, determine a respective dimming factor that reduces the respective original pixel intensity, and wherein the dimming factor ranges from a minimum amount adjacent to the bounding box to a maximum amount at an edge of the video frame; create a dimmed background by applying to the individual background pixels, the respective dimming factor; and cause the display component to display a converted video frame with the dimmed background.

Example 2 includes the subject matter of Example 1, wherein the minimum amount is in a range of 0.001% to 0.01% and the maximum amount is in a range of 20% to 50%.

Example 3 includes the subject matter of Example 1 or Example 2, wherein the dimming factor further has a rate of change that is at least 20% higher near a periphery of the video frame than near the bounding box.

Example 4 includes the subject matter of any one of Examples 1-3, wherein the control circuit is further configured to: perform object recognition on the background; and determine that the background is not meaningful by comparing an output from the object recognition to contents in a lookup table.

Example 5 includes the subject matter of any one of Examples 1-3, further comprising: an artificial intelligence (AI) model that has been trained with training data defining meaningful objects and text; wherein the control circuit is further configured to: supply the background to the AI model; and determine that the background is not meaningful with an output from the AI model.

Example 6 includes the subject matter of any one of Examples 1-5, wherein the control circuit is further configured to: determine that the background is meaningful; cease applying to the individual background pixels, the respective dimming factor; and cause the display component to display the video frame with, for the plurality of pixels, the respective original pixel intensity.

Example 7 includes the subject matter of any one of Examples 1-6, wherein the display component comprises an organic light emitting diode (OLED) display panel.

Example 8 includes the subject matter of any one of Examples 1-6, wherein the display component comprises a light emitting diode (LED) display panel.

Example 9 includes the subject matter of any one of Examples 1-8, wherein the mixed media data signal is associated with a video conferencing application.

Example 10 includes the subject matter of any one of Examples 1-9, wherein the control circuit is further to: perform a person detection or segmentation operation with boxes or polygons; and delineate the person in the video frame from the background with the bounding box responsive to performing the person detection and segmentation operation.

Example 11 includes the subject matter of any one of Examples 1-10, wherein the control circuit is further to: detect when an audio or video conferencing application is not running in a foreground mode; and cause the display component to cease displaying when the audio or video conferencing application is not running in the foreground mode.

Example 12 is a non-transitory computer-readable media comprising instructions that are, when executed by processing circuitry, to: receive a video frame from a video conferencing application on an external device; receive metadata associated with the video frame, wherein the metadata delineates a person from a background in the video frame using a bounding box; and wherein the metadata associated with the video frame further provides a background blur flag that is asserted when the background is not meaningful; wherein the video frame comprises, for a plurality of pixels, a respective original pixel intensity; identify pixels of the plurality of pixels that are associated with the background as background pixels; for individual background pixels, determine a respective dimming factor that reduces the respective original pixel intensity, and wherein the dimming factor ranges from a minimum amount adjacent to the bounding box to a maximum amount at an edge of the video frame; create a dimmed background by applying to the individual background pixels, the respective dimming factor; and cause a display component to display a converted video frame with the dimmed background.

Example 13 includes the subject matter of Example 12, wherein the instructions are further to implement the minimum amount in a range of 0.001% to 0.01% and the maximum amount in a range of 20% to 50%.

Example 14 includes the subject matter of Example 12 or Example 13, wherein the instructions are further to determine the dimming factor more frequently adjacent to the bounding box than at a periphery of the video frame.

Example 15 includes the subject matter any one of Examples 12-14, wherein the instructions are further to: detect when the background blur flag is de-asserted; and cause the display component to display the video frame with, for the plurality of pixels, the respective original pixel intensity.

Example 16 includes the subject matter of any one of Examples 12-14, wherein the instructions are further to: detect when the background blur flag is de-asserted; identify pixels of the plurality of pixels that are associated with the background as background pixels; for individual background pixels, determine a respective dimming factor that reduces the respective original pixel intensity, and wherein the dimming factor ranges from a minimum amount adjacent to the bounding box to a maximum amount at an edge of the video frame; create a dimmed background by applying to the individual background pixels, the respective dimming factor; and cause the display component to display a converted video frame with the dimmed background.

Example 17 includes the subject matter of any one of Examples 12-16, wherein the instructions are further to: detect when an audio or video conferencing application is not running in a foreground mode; and cause the display component to cease displaying when the audio or video conferencing application is not running in the foreground mode.

Example 18 is a system, comprising: a display component comprising display electronics; and a means for means for management of display electronics, wherein the means for management of display electronics is to: receive a mixed media data signal from an external device; create a video frame from the mixed media data signal; delineate a person in the video frame from a background with a bounding box; determine that the background is not meaningful; wherein the video frame comprises, for a plurality of pixels, a respective original pixel intensity; identify pixels of the plurality of pixels that are associated with the background as background pixels; for individual background pixels, determine a respective dimming factor that reduces the respective original pixel intensity, and wherein the dimming factor ranges from a minimum amount adjacent to the bounding box, the minimum amount between 0.001% and 0.01%, and a maximum amount between 20% and 50%, the maximum amount at an edge of the video frame; create a dimmed background by applying to the individual background pixels, the respective dimming factor; and cause the display electronics to display a converted video frame with the dimmed background.

Example 19 includes the subject matter of Example 18, wherein the means for management of display electronics further varies the dimming factor with a rate of change that is at least 20% higher adjacent to the bounding box than the rate of change at a periphery of the video frame.

Example 20 includes the subject matter of Example 19, further comprising: a means for classifying the background, wherein the means for classifying the background is to determine whether the background is meaningful; and wherein the means for management of display electronics is further to: cease applying to the individual background pixels, the respective dimming factor, when it is determined that the background is meaningful.

Example 21 includes the subject matter of Example 1, wherein the bounding box may be one of an n-sided polygon, a curved shape, generated by depth information, or a combination thereof; and wherein the respective dimming factor varies non-linearly as a function of distance from the bounding box.

What is claimed is:

1. A system, comprising:
a display component associated with a user device; and
a control circuit coupled to the display component, the control circuit to:
receive a mixed media data signal from an external device;
create a video frame from the mixed media data signal;
delineate a person in the video frame from a background with a bounding box;
determine that the background is not meaningful;
wherein the video frame comprises, for a plurality of pixels, a respective original pixel intensity;
identify pixels of the plurality of pixels that are associated with the background as background pixels;
for individual background pixels, determine a respective dimming factor that reduces the respective original pixel intensity, wherein the dimming factor is a function of distance from the bounding box and ranges from a minimum amount adjacent to the bounding box to a maximum amount at an edge of the video frame;
create a dimmed background by applying to the individual background pixels, the respective dimming factor; and
cause the display component to display a converted video frame with the dimmed background.

2. The system of claim 1, wherein the bounding box may be one of an n-sided polygon, a curved shape, generated by depth information, or a combination thereof; and wherein the respective dimming factor varies non-linearly as a function of distance from the bounding box.

3. The system of claim 1, wherein the dimming factor further has a rate of change that is at least 20% higher near a periphery of the video frame than near the bounding box.

4. The system of claim 1, wherein the control circuit is further configured to:
perform object recognition on the background; and
determine that the background is not meaningful by classifying an output from the object recognition or comparing an output from the object recognition to contents in a lookup table.

5. The system of claim 1, further comprising:
an artificial intelligence (AI) model that has been trained with training data defining meaningful objects or text;
wherein the control circuit is further configured to:
supply the background to the AI model; and
determine that the background is not meaningful based on an output of the AI model.

6. The system of claim 1, wherein the control circuit is further configured to:
determine that the background is meaningful;
cease applying to the individual background pixels, the respective dimming factor; and
cause the display component to display the video frame with, for the plurality of pixels, the respective original pixel intensity.

7. The system of claim 1, wherein the display component comprises an organic light emitting diode (OLED) display panel.

8. The system of claim 1, wherein the display component comprises a light emitting diode (LED) display panel.

9. The system of claim 1, wherein the mixed media data signal is associated with a video conferencing application.

10. The system of claim 1, wherein the control circuit is further to:
perform a person detection and segmentation operation; and
delineate the person in the video frame from the background with the bounding box responsive to performing the person detection and segmentation operation.

11. The system of claim 1, wherein the control circuit is further to:
detect when an audio or video conferencing application is not running in a foreground mode; and
cause the display component to cease displaying when the audio or video conferencing application is not running in the foreground mode.

12. A non-transitory computer-readable media comprising instructions that are, when executed by processing circuitry, to:
receive a video frame from a video conferencing application on an external device;
receive metadata associated with the video frame, wherein the metadata delineates a person from a background in the video frame using a bounding box, and wherein the bounding box may be one of an n-sided polygon, a curved shape, generated by depth information, or a combination thereof;
and wherein the metadata associated with the video frame further provides a background blur flag that is asserted when the background is not meaningful;
wherein the video frame comprises, for a plurality of pixels, a respective original pixel intensity;
identify pixels of the plurality of pixels that are associated with the background as background pixels;
for individual background pixels, determine a respective dimming factor that reduces the respective original pixel intensity, and wherein the dimming factor is a function of distance from the bounding box, and ranges from a minimum amount adjacent to the bounding box to a maximum amount at an edge of the video frame;
create a dimmed background by applying to the individual background pixels, the respective dimming factor; and
cause a display component to display a converted video frame with the dimmed background.

13. The non-transitory computer-readable media of claim 12, wherein the instructions are further to vary the respective dimming factor non-linearly as a function of distance from the bounding box.

14. The non-transitory computer-readable media of claim 12, wherein the instructions are further to implement the dimming factor further by changing it more frequently closer to the bounding box than at a periphery of the video frame.

15. The non-transitory computer-readable media of claim 12, wherein the instructions are further to:
detect when the background blur flag is de-asserted; and
cause the display component to display the video frame with, for the plurality of pixels, the respective original pixel intensity.

16. The non-transitory computer-readable media of claim 12, wherein the instructions are further to:
detect when the background blur flag is de-asserted;
identify pixels of the plurality of pixels that are associated with the background as background pixels;
for individual background pixels, determine a respective dimming factor that reduces the respective original pixel intensity, and wherein the respective dimming factor is a function of distance from the bounding box and ranges from a minimum amount adjacent to the bounding box to a maximum amount at an edge of the video frame;
create a dimmed background by applying to the individual background pixels, the respective dimming factor; and
cause the display component to display a converted video frame with the dimmed background.

17. The non-transitory computer-readable media of claim 12, wherein the instructions are further to:
detect when an audio or video conferencing application is not running in a foreground; and
cause the display component to cease displaying when the audio or video conferencing application is not running in the foreground.

18. A system, comprising:
a display component comprising display electronics; and
a means for management of the display electronics, wherein the means for management of the display electronics is to:
receive a mixed media data signal from an external device;
create a video frame from the mixed media data signal;
delineate a person in the video frame from a background with a bounding box;
determine that the background is not meaningful;
wherein the video frame comprises, for a plurality of pixels, a respective original pixel intensity;
identify pixels of the plurality of pixels that are associated with the background as background pixels;
for individual background pixels, determine a respective dimming factor that reduces the respective original pixel intensity, and wherein the dimming factor is a function of distance from the bounding box and ranges from a minimum amount adjacent to the bounding box and a maximum amount at an edge of the video frame;
create a dimmed background by applying to the individual background pixels, the respective dimming factor; and
cause the display electronics to display a converted video frame with the dimmed background.

19. The system of claim 18, wherein the means for management of the display electronics further varies the dimming factor with a rate of change that is at least 20% higher at a periphery of the video frame than adjacent to the bounding box.

20. The system of claim 19, further comprising:
a means for classifying the background, wherein the means for classifying the background is to determine whether the background is meaningful; and
wherein the means for management of the display electronics is further to:
cease applying to the individual background pixels, the respective dimming factor, when it is determined that the background is meaningful.
